(19) United States
(12) Patent Application Publication
(10) Pub. No.: US 2006/0249874 A1
(43) Pub. Date: Nov. 9, 2006

(54) Elongate body for forming profiles in a castable material

(76) Inventor: Kyozaburo Takagi, Centerville, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/482,077

(22) Filed: Jul. 6, 2006

Related U.S. Application Data
(62) Division of application No. 10/453,456, filed on Jun. 3, 2003.
(60) Provisional application No. 60/387,380, filed on Jun. 10, 2002.

(51) Int. Cl. B28B 3/00; B29C 71/00

(52) U.S. Cl. 264/236; 264/333

(57) ABSTRACT

An elongate body for forming profiles in a castable material. The body includes support structure to promote dimensional stability of the body when subjected to loads imposed by the weight of the castable material. In one form, the support structure can be of a hollow, preferably extruded, construction, while in another, the entire body can be of a foamed construction. The elongate body includes a topographic feature in at least one surface such that upon formation of a precast panel that includes profiles formed by the body, the topographic feature creates a relief in portions of the profile. The relief may be in the form of a decorative design or the like. In addition, the elongate body may include enhanced sealing features and a fastening adapter to facilitate improved connection between the body and a surface upon which a precast panel is to be formed.

### CROSS REFERENCE TO RELATED APPLICATION

This application is a divisional of co-pending application Ser. No. 10/453,456, filed Jun. 3, 2003.

### BACKGROUND OF THE INVENTION

The present invention relates to a device used for creating a profile in cured concrete and other castable materials.

In the construction of buildings, especially those used in commercial and industrial applications, precast panels are made from castable material, such as concrete. Precast panels are integral to the tilt-up construction process, and are commonly formed by using a panel-forming surface (such as a concrete building floor) that is coated with a release agent to define a horizontal forming surface for the wall panels. Forms for producing the concrete wall panels are then placed on the panel-forming surface in a predetermined pattern, after which reinforcing steel (such as rebar) may be positioned within the forms. When concrete is poured within the shape defined by the forms, the top edges of the forms are used as a guide for a screed to form one of the flat surfaces of the wall panels. After the concrete wall panels are cured, the forms are removed, and the panels are lifted or tilted by a crane to preferred, typically vertical, positions to form the building walls, where they can be joined to structural frames or other panels. When it is desired to form profiles, such as reveal bands, in the castable material, profile-forming strips (sometimes referred to as rustications) are placed on the panel-forming surface prior to pouring the concrete, thus allowing a shape coincident with the strip to be formed in the concrete. Typically, the strips are treated or sprayed with a concrete release agent prior to panel formation to promote separation and subsequent reuse of the strips.

### SUMMARY OF THE INVENTION

The present inventors have recognized that a limitation to prior art rustication devices is that none of them can form a decorative pattern or related design on the surface of the reveal band. Therefore, a need exists for a rustication device that can easily and efficiently place a decorative pattern on the surfaces of wall panels. In addition, the present inventors have found that a need exists for such a rustication device that can be easily secured to the panel-forming surface. The needs are met by the present invention, wherein an improved rustication device is disclosed that has applicability in tilt-up and other construction processes that utilize castable materials.

According to a first aspect of the invention, an elongate body comprising a support structure, at least one upward-facing surface supported by the support structure, and a topographic feature formed on the upward-facing surface is disclosed. The upward-facing surface defines in the body a height dimension and a width dimension, while the upward facing surface and the topographic feature are configured to form a profile in a castable material. The support structure and the upward facing surface are configured to give the body a structural rigidity such that upon placement of the body onto a panel-forming surface and subsequent placement of the castable material over or around the body, the body is substantially resistant to deformation caused by the castable material. In the present context, the term “substantially” refers to features that, while in theory would be expected to exhibit exact correspondence or behavior, may in practice embody something slightly less than exact. As such, the term denotes the degree by which a quantitative value, measurement or other related representation may vary from a stated reference without resulting in a change in the basic function of the subject matter at issue. As such, “designed-in” deformation is permissible and is understood to not be destructive of the claim requirement. By way of example, one attribute of at least one embodiment of the structure of the present invention elongate body is that sealing edges (described below) are configured to splay under a load caused by the weight of castable material placed on or around the body. This type of deformation, having been designed into the device, would not be inconsistent with the claimed requirement, as such deformation not only does not change the basic function of the device, but is in fact consistent with it. By contrast, undue flexural or edgewise bending or surface undulations produced under the load of the castable material would be the type of deformation the present invention avoids, as such deformation, if allowed, would significantly effect the dimensions or surface properties of the body and the finished reveal band produced by that body.

Optionally, the topographic feature is a decorative pattern, and more preferably, the decorative pattern is a repeating pattern. In one form, the decorative pattern is integrally formed with the upward-facing surface. As another option, the body further includes at least one downward-facing surface configured to engage the panel-forming surface. In addition, the body includes pair of laterally-spaced sidewalls that extend between the upward-facing and downward-facing surfaces. Furthermore, each of the laterally-spaced sidewalls includes a sloping wall that at least partially defines the profile formed in the castable material. In another option, at least a portion of the downward-facing surface terminates in a sealing edge. This allows the body to have enhanced sealing engagement with the panel forming surface when a load due to the presence of the castable material is over the body and the panel-forming surface. In one form, the sealing edge is substantially coplanar with an outward-facing surface of a corresponding one of the laterally-spaced sidewalls. In another, the sealing edge extends laterally beyond a plane defined by a corresponding one of the laterally-spaced sidewalls. In yet another option, a fastening adapter is coupled to at least one of the downward-facing surface or the pair of laterally-spaced sidewalls. Moreover, the fastening adapter is integrally formed with one of the pair of laterally-spaced sidewalls, and defines an aperture therein to facilitate the securing of the body to the panel-forming surface. In another form, the fastening adapter comprises at least one locking mechanism to facilitate clamping a portion of the downward-facing surface to the panel forming surface. A hinge may also be added such that it can connect the body and the fastening adapter. The hinge may comprise a line of weakness formed into the sidewall. In yet another option, the body defines a substantially trapezoidal-shaped cross section, while in still another option, the body defines a substantially triangular-shaped cross section, where more particularly a downward-facing surface in the triangular-shaped cross section terminates in a sealing edge such that upon placement of the castable material over the body and the panel-forming surface, the body exhibits enhanced sealing engagement with the panel forming surface. In one form, the fastening adapter is a base clip. Preferably, the base clip and the body comprise complementary surfaces such that a snap-fit engagement between the two may be affected. In still another option, the upward-facing surface is situated below the pair of laterally-spaced sidewalls when the body is placed on the panel-forming surface such that the upwardly-facing surface defines a valley into which the castable material may be placed.

As another option, the support structure can be extruded. As will be appreciated by those familiar with the art of extrusion, an extruded member defines a substantially uniform extruded cross section that extends along substantially the entire length of the member. Insignificant variations in the uniformity of the cross section due to fabrication process errors or post fabrication process steps are contemplated. For example, holes may be drilled in an extruded member in specific locations, while cuts or cutouts may be formed in the extruded member, all after the member is extruded. Also, as shown and described in the present invention, topographic features may be added to one or more surfaces of the member after it has been extruded. In yet another option, the support structure may additionally include a plurality of laterally-spaced stringers. As with the remainder of the support, the stringers may also be extruded. These stringers can enhance the structural rigidity of the body, thus making it more resistant to bending and surface undulations that otherwise may form due to the weight of the castable material. The body may further include a base clip that can be engaged with at least one of the stringers. In one form, the base clip and the at least one stringer have complementary surfaces such that a snap-fit engagement between the two may be affected. An example of such complementary surfaces can be a plurality of interlocking teeth. As an alternate to the extruded construction mentioned above, the body can be made of foamed construction. With either construction, the deformations that the body is substantially resistant to is flexural deformation, edgewise deformation and surface undulation. Both flexural and edgewise deformation are part of a larger class of bending deformation, where flexural bending is commonly along the longitudinal dimension of the device and normal to the plane defined by the lower moment of inertia, while edgewise bending is commonly along the longitudinal dimension of the device and normal to the plane defined by the higher moment of inertia. Surface undulation includes any dents, curvature, waviness or related change of shape of a discrete part of the surface of the object due to the presence of a load on the device. For example, a surface undulation in the form of a sag can be produced in a relatively unsupported part of a device when a load (such as a weight) is imparted to the device.

According to another aspect of the invention, a rustication body for preparing reveal bands in the surface of a precast panel is disclosed. The rustication includes an upper surface configured to engage the surface of the panel, a lower surface configured to engage a panel-forming surface, a pair of laterally-spaced sidewall surfaces that extend between the upper and lower surfaces and a decorative pattern disposed on the upper surface, the decorative pattern configured to impart topographic features into the panel. Optional features similar to those of the previous aspect may also be included with the rustication.

According to yet another aspect of the invention, a method of manufacturing a profile into a panel is disclosed. The method includes configuring an elongate body similar to that of the previously-discussed first aspect, placing the body on the panel-forming surface, introducing castable material to the body while the castable material is in an uncured state, curing the castable material and removing the body from the cured panel. In the present context, a panel is considered to be cured when the shape it assumes in its as-cast condition is sufficiently stable such that when forming devices used to define the panel are removed, the panel can maintain that shape. Optionally, the method may encompass additional steps, including securing the body to the panel-forming surface prior to the step of introducing the castable material, configuring the body to include at least one downward-facing surface to engage the panel-forming surface prior to introducing the castable material, and configuring at least a portion of the downward-facing surface to terminate in a sealing edge such that upon the introducing step, the body exhibits enhanced sealing engagement with the panel forming surface.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals and in which:

FIG. 1 is perspective view of a rustication according to an embodiment of the present invention;

FIGS. 2A through 2D illustrate examples of decorative patterns that can be used in the present invention;

FIG. 3 illustrates an end view of an alternative embodiment of the present invention;

FIG. 4 illustrates an end view of an alternative embodiment of the present invention;

FIG. 5 illustrates an end view of an alternative embodiment of the present invention;

FIG. 6 illustrates an end view of an alternative embodiment of the present invention;

FIG. 7 illustrates a triangular-shaped embodiment of the present invention;

FIG. 8 illustrates a trapezoidal-shaped embodiment of the present invention; and

FIG. 9 illustrates a variation of the embodiment of FIG. 8.

### DETAILED DESCRIPTION OF THE PREFERRED EMBODIMENTS

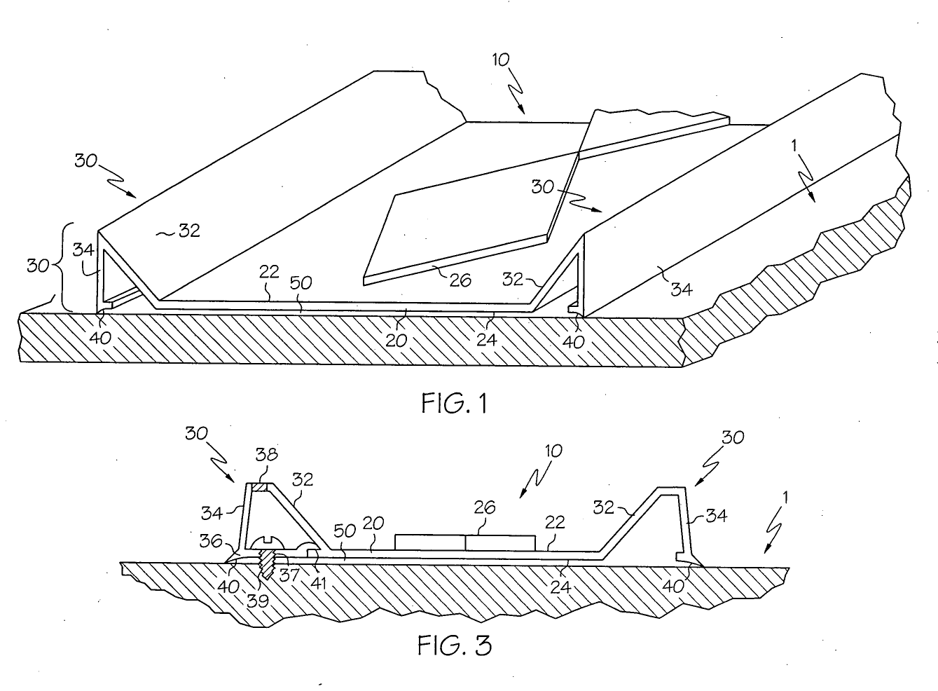

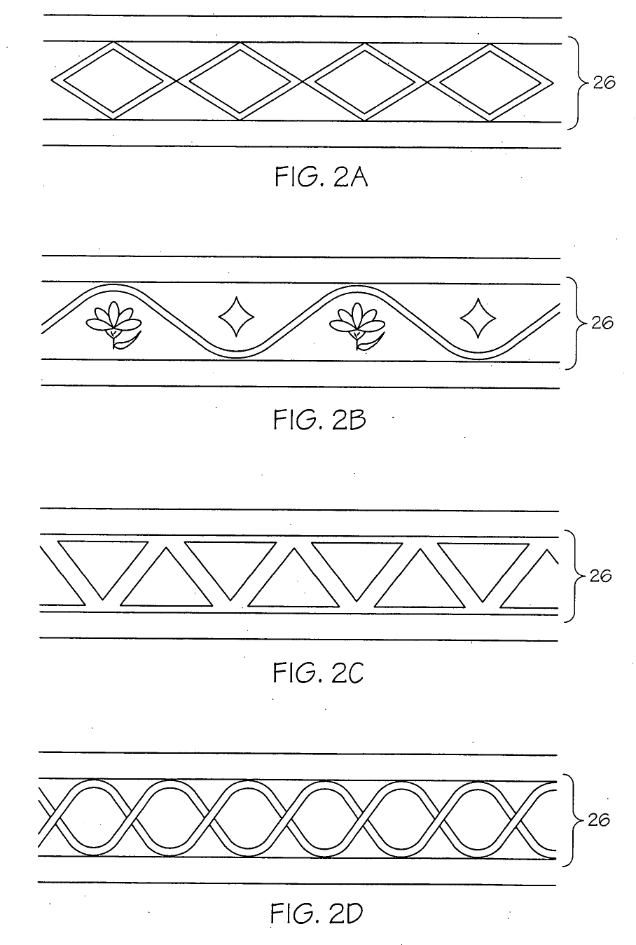

Referring initially to FIGS. 1 and 2A through 2D, a rustication 10 with topographic features according one embodiment of the present invention is illustrated. The entire rustication 10 is a one-piece elongate body made from a semi-rigid plastics material such as polyvinylchloride (PVC), high density polyethylene (HDPE) or the like. In one form, rustication 10 can be made from conventional forming techniques, including extrusion. The rustication 10 includes a center section 20 and a pair of laterally-spaced sidewalls 30 that extend from the center section 20. The center section 20 includes an upward-facing surface 22 and a downward-facing surface 24 such that the downward-facing surface 24 can be placed adjacent a panel-forming surface 1 (which is typically in the form of a smooth floor or related slab). Any conventional adhesive or fastening means can be used to secure the downward-facing surface 24 of rustication 10 to the panel-forming surface 1. The upward-facing surface 22 of the center is opposite the downward-facing surface 24. Center section 20 includes topographic features, in the form of a decorative pattern area 26, where a pattern or related design can be formed in the rustication 10 so that when the concrete for the concrete wall panel is poured over the rustication 10, the cement will harden around the decorative pattern. In one form, the pattern is embossed in the decorative pattern area 26 after the rustication 10 has been extruded, where the decorative pattern can be embossed either before or after cooling of the center section 20. If the decorative pattern is embossed after cooling, then the center section 20 is preferably heated before the decorative pattern is embossed to promote diffusion and attendant thermal bonding. Once the concrete wall panel is lifted into place, the rustication 10 can be separated from the panel, leaving a profile of the decorative pattern area 26 cast into the panel. As shown with particularity in FIGS. 2A through 2D, a few examples of repeating topographic features that can be placed in the decorative pattern area 26 are shown; however, it will be appreciated by those skilled in the art that numerous other suitable patterns can be made, depending on user need. The topographic features project above the plane formed by central section 20 so that a corresponding indentation is produced in the profile formed in the precast panel by rustication 10.

Each of the laterally-spaced sidewalls 30 includes an inner wall 32 and an outer wall 34. The inner wall 32 is canted, with its surface that is configured to help define the shape of a profile formed in a precast panel extending in an upwardly-facing direction. In the present context, a surface is upwardly facing if a normal projection therefrom includes a vertically upward component. Thus, both the center section 20 (which is shown in the figure as facing the generally horizontal plane of the panel-forming surface 1) and the inner wall 32 (which is shown in the figure as facing 45 degrees zenith relative to the generally horizontal plane of the panel-forming surface 1) of sidewall 30, are considered to be upward-facing. The outer wall 34 is disposed laterally beyond each inner wall 32, and terminates in its downward-facing end in a sealing edge 40. The sealing edges 40 extend below a plane defined by the downward-facing surface 24 so that, upon placement of uncured concrete in and around the rustication 10, the weight of the concrete causes the sealing edge 40 to splay, thereby creating a seal and preventing the leakage of cement or related materials into the region between the rustication 10 and the panel-forming surface 1. As shown, the outward-facing surface of sealing edge 40 and outer wall 34 are substantially coplanar with one another. In other configurations (shown and described below), the sealing edge 40 may extend laterally beyond the outer wall 34. As can be seen in the figure, the lowermost portion of sealing edge 40 lies below a plane formed by downward-facing surface 24, thus forming a gap 50 between the downward-facing surface 24 and panel-forming surface 1. When a load is placed on rustication 10 (such as from concrete being poured over it), the center section 20 sags until contacting panel-forming surface 1. By imparting its weight onto inner wall 32, the load also encourages sealing edge 40 to splay, thereby improving the sealing between the panel-forming surface 1 and rustication 10.

Referring next to FIG. 3, a rustication 10 as described above for FIG. 1 is provided, now modified to include both a fastening adapter 36 and a canted outer wall 34 of sidewall 30. In this configuration, the fastening adapter 36 is integrally formed with one of the laterally-spaced sidewalls 30. In addition, a hinge 38 is used to couple inner wall 32 to the outer wall 34. In one form, hinge 38 can be formed from a line of weakness, such as a thinned-out portion in the surface of rustication 10. In the alternate, the hinge 38 can be formed of a softer, more pliable plastic through co-extrusion. The hinge 38 aids in the placement of the rustication on the concrete forming surface, as the entire rustication 10 except for the outer wall 34 adjacent the fastening adapter 36 is bent upward with the help of the hinge 38. A portion of the rustication 10 that is adjacent the fastening adapter 36 is secured to the panel-forming surface 1 by a fastener 39 (such as a screw, as shown, or nail) that is passed through a groove 37 (which could also be an aperture) defined in the top center of the fastening adapter 36. Once the fastening adapter 36 and sealing edge 40 of the outer wall 34 are secured, the remainder of the rustication 10 is bent toward the panel-forming surface 1 by using the hinge 38. The fastening adapter 36 includes a locking mechanism 41 so that to the downward-facing surface 24 of the center section 20 can be better secured to the panel-forming surface 1 through the fastening adapter 36 by locking the former into place with the latter. The slight outward cant of the lower portion of outer wall 34 relative to its upper portion promotes the splaying of sealing edge 40 when concrete or other uncured castable material is poured around rustication 10. In addition, unlike the embodiment depicted in FIG. 1, the sealing edges 40 project laterally beyond a plane formed by the outer wall 34. As before, the dimension of sealing edge 40 is sufficient to ensure that a gap 50 is present between downward-facing surface 24 and panel-forming surface 1 prior to concrete being poured over the rustication 10. The dimensions of sealing edge 40 are shown exaggerated to emphasize both the downward-projecting nature of the sealing edge 40, as well as gap 50.

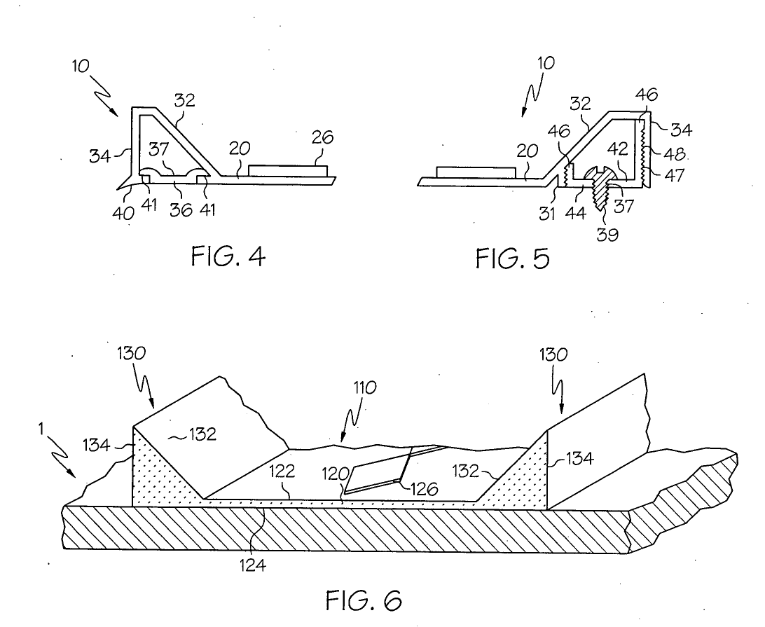

Referring next to FIGS. 4 and 5, an alternate form of the fastening adapter 36 is shown, where, instead of being integrally formed with one of the laterally-spaced sidewalls 30 of rustication 10, it is made of a discrete piece. This has the advantage of allowing the user to first secure the fastening adapter 36 without having other parts of the rustication 10 getting in the way. In the configuration shown with particularity in FIG. 4, the fastening adapter 36 has two locking mechanisms 41, each on opposing sides. Once the fastening adapter 36 is secured to the panel-forming surface 1 (through fastener, adhesive or the like, none of which are presently shown), the outer wall 34 with the sealing edge 40 can be slid such that a detent projecting inward from the sealing edge 40 can fit underneath one of the locking mechanisms 41, while the other locking mechanism 41 can be snapped into place. In an alternate configuration, detents from both the outer wall 34 and the downward-facing surface 24 can be snapped in place over both locking mechanisms 41. Either or both the detents and the locking mechanisms 41 can be made to be elastically compliant to facilitate a snap-fit engagement between them; this can be accomplished through judicious material choice, component thickness, or both. Referring with particularity to FIG. 5, a variation of the rustication 10 shown in FIG. 1 is provided. The rustication 10 includes a protrusion 31 that extends from the lower portion of the inner wall 32. A fastening adapter in the form of a base clip 42 helps secure the rustication 10 to the panel-forming surface (not presently shown). The base clip 42 comprises a bottom wall 44 and a pair of laterally spaced sidewalls 46, which have outwardly projecting teeth 48 that lock into the rustication 10 by engaging a complementary series of inwardly projecting teeth 47 of the outer wall 34 and a series of inwardly projecting teeth 47 of the protrusion 31 of the inner wall 32 such that a snap-fit engagement between base clip 42 and rustication 10 is formed. The base clip 42 includes a groove 37 that extends within the top center of the bottom wall 44. The groove 37 can receive a fastening device 39, such as a nail or screw, which secures the rustication 10 to the forming surface. In the alternate, groove 37 can be an aperture extending all the way through base clip 42.

Referring next to FIG. 6, a rustication 110 according to another embodiment of the present invention is illustrated. The entire rustication 110 is a one-piece member that can be made from extruded foam, thus revealing a porous core (internal) structure. The rustication 110 includes a center section 120 and a pair of laterally-spaced sidewalls 130 that extend from the center section 120. The center section 120 includes an upward-facing surface 122 and a downward-facing surface 124. The downward-facing surface 124 can rest on a panel-forming surface. The upward-facing surface 122 of the center section 120 includes a decorative pattern area 126 where a decorative pattern can be formed in the rustication 110. Preferably during the extrusion process, a smooth, sealed out skin is formed that covers at least the upward-facing surface 122 of the center section 120 and the laterally-spaced sidewalls 130. While the outer skin (and details related thereto) is not the subject of the present invention, the skin is relatively nonporous compared to that of a porous core such that it is substantially impenetrable to water and related liquids inherent in poured concrete. The presence of the relatively non-porous outer skin is beneficial in that it affects improved release properties upon concrete curing relative to a porous surface. To further reduce cost and weight, while still providing the requisite structural rigidity and resistance to warping, the foamed material can be polystyrene, PVC, acrylonitrile-butadiene-styrene (ABS) or related material. The foam can be either closed cell (where the majority of the cells are non-interconnecting), open cell (where many of the cells do interconnect), syntactic (where rigid microspheres are dispersed in a fluid polymer, then cured) or other conventional foamed structure. The nonporous outer skin can be an additional contributor to overall rustication rigidity. In the present context, the skin is formed from the same foamed material as that of porous core, with a higher density to promote the formation of the aforementioned liquid-resistant surface properties due to its relatively nonporous, shell-like configuration.

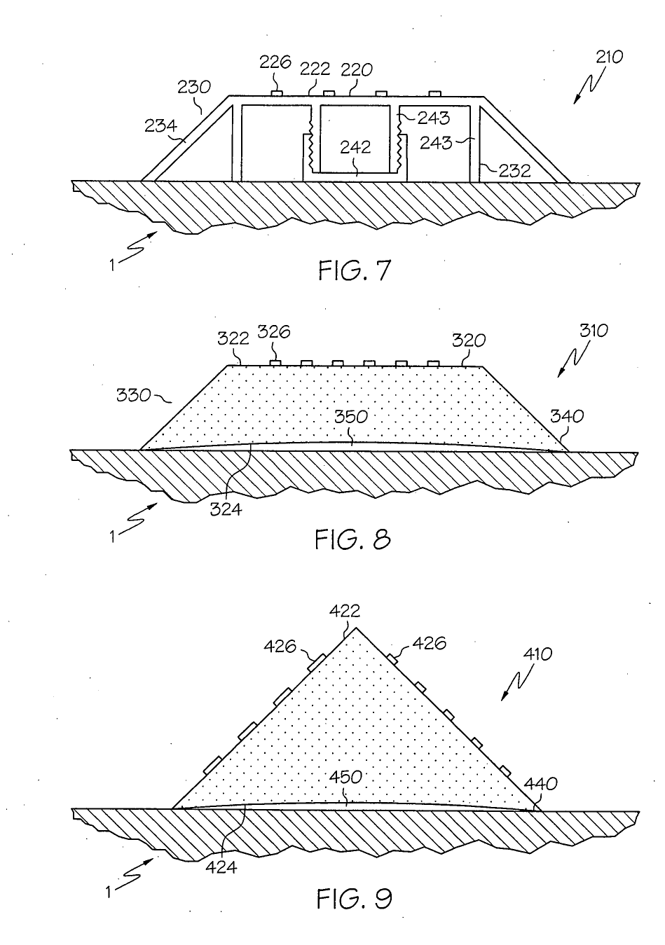

Referring next to FIG. 7, a rustication 210 according to another embodiment of the present invention is illustrated. In this embodiment, its generally elongate body includes, in addition to center section 220 and laterally-spaced sidewalls 230, a plurality of stringers 243 to enhance the resistance of rustication 210 to deformation under load. The stringers can be integrally formed with the center section 220 or the laterally-spaced sidewalls 230, where in the latter case the stringer 243 may define an inner wall 232. In addition, the stringers 243 can be made to form an interlocking fit with a base clip 242 to help secure rustication 210 to panel-forming surface 1. Topographic features 226 (shown in this instance as a series of discrete decorative patterns) are added to, or formed in, upward-facing surface 222 of center section 220. Although not presently shown, the lowermost parts of outer wall 234 can terminate in a sealing edge. As with the previous embodiments, the rustication 210 can be formed from an extruded part. Unlike the embodiment depicted in FIGS. 1 and 3 through 6, the uppermost part of center section 220 of rustication 210 is situated vertically higher than the sidewalls 230.

Referring next to FIGS. 8 and 9, two variations of a foamed rustication 310, 410 are shown. As with the embodiment shown in FIG. 7, the portion containing the topographic features 326, 426 is situated vertically higher than the sidewalls 330. Gaps 350, 450 are formed in downward-facing surfaces 324, 424 so that the lowermost contact points can form sealing edges 340, 440. As with the sealing edge 40 shown in FIG. 3, sealing edges 340, 440 are shown exaggerated for illustrative purposes. The triangular-shaped rustication 410 of FIG. 9 is a degenerate trapezoid, such that the center section 320 and laterally-spaced sidewall sections 330 of the trapezoidal device of FIG. 8 converge into an apex. Thus, the triangular-shaped rustication preserves the attributes of both the sidewalls and center section without having to form separate surface facets. This contributes to low-cost manufacturing, especially when the rustication is formed as an extruded part. It will be appreciated by those skilled in the art that other shapes may be contemplated, and that such shapes fall within the spirit of the present invention.

Having described the invention in detail and by reference to preferred embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of manufacturing a decorative profile into a panel made from a castable material, said method comprising:
configuring an elongate body to include at least one upward-facing surface that defines a decorative topographic feature thereon;
placing said body on a panel-forming surface;
placing castable material over said body while said castable material is in an uncured state so that a profile defined by said upward facing surface and said decorative topographic feature forms in at least a portion of said castable material; and
curing said castable material to form said panel.

2. The method of claim 1, further comprising securing said body to said panel-forming surface prior to introducing said castable material.

3. The method of claim 1, further comprising configuring said body to include at least one downward-facing surface to engage said panel-forming surface prior to introducing said castable material.

4. The method of claim 3, further comprising configuring at least a portion of said downward-facing surface to terminate in a sealing edge such that upon said introducing, said body exhibits enhanced sealing engagement with said panel-forming surface.

5. The method of claim 1, further comprising removing said body from said cured panel.

6. The method of claim 1, wherein said elongate body comprises a rustication.

7. The method of claim 6, wherein said decorative topographic feature of said rustication comprises a plurality of repeating decorative topographic features.

8. The method of claim 1, wherein said profile does not extend all of the way through said panel.

9. The method of claim 1, wherein a projection into said panel by said upward facing surface alone is greater than a projection into said panel by said decorative topographic feature alone.

10. A method of forming a profile in a precast panel, said method comprising:
configuring an elongate body to comprise:
an upper surface configured to engage a surface of said precast panel;
a lower surface configured to engage a panel-forming surface; and
a decorative pattern disposed on said upper surface, said decorative pattern configured to impart at least one topographic feature into said precast panel;
placing said body on a panel-forming surface;
placing castable material over said body while said castable material is in an uncured state such that a substantial majority of the thickness of said profile formed into said precast panel by said body is defined by the projection associated with said upper surface alone than due to said topographic feature alone; and
curing said castable material to form said panel.

11. The method of claim 10, further comprising removing said body from said cured panel.

12. The method of claim 10, wherein said at least one decorative topographic feature comprises a plurality of repeating decorative topographic features.

13. The method of claim 12, wherein said repeating decorative topographic features repeat along a longitudinal dimension of said elongate body.

14. The method of claim 10, wherein said profile does not extend all of the way through said panel.

15. A method of forming a decorative profile in a precast panel, said method comprising:
configuring an elongate body to comprise:
a downward-facing surface configured to engage a panel-forming surface;
an upward-facing surface configured to receive a castable material thereon; and
a topographic feature formed on at least a portion of said upward-facing surface;
placing said body on a panel-forming surface;
placing castable material over said body while said castable material is in an uncured state so that said body forms a profile comprising said upward-facing surface and said topographic feature in said castable material such that a larger portion of the depth of said profile is due to the projection into said castable material associated with said upward-facing surface alone than due to the projection into said castable material associated with said topographic feature alone; and
curing said castable material to form said panel.

16. The method of claim 15, wherein said profile does not extend all of the way through said panel.

17. The method of claim 15, wherein said topographic feature comprises a decorative projection that can be formed in said panel.

18. The method of claim 17, wherein said decorative projection comprises a repeating pattern.
